(19) United States
(12) Patent Application Publication
(10) Pub. No.: US 2016/0110778 A1
(43) Pub. Date: Apr. 21, 2016

(54) CONDITIONAL ANALYSIS OF BUSINESS REVIEWS

(71) Applicant: International Business Machines Corporation, Armonk, NY (US)

(72) Inventors: James E. Bostick, Austin, TX (US); Donna K. Byron, Boston, MA (US); John M. Ganci, JR., Cary, NC (US); Craig M.A. Trim, Sylmar, CA (US)

(73) Assignee: International Business Machines Corporation, Armonk, NY (US)

(21) Appl. No.: 14/516,725

(22) Filed: Oct. 17, 2014

(51) Int. Cl. G06Q 30/02; G06F 3/06; G06F 17/30

(52) U.S. Cl. CPC G06Q 30/0282; G06F 17/30663; G06F 3/067; G06F 3/065; G06F 3/0619

(57) ABSTRACT

A method, system, and computer program product for conditional analysis of business reviews are provided in the illustrative embodiments. A request, directed to an application executing in a data processing system, for a report on a business entity is detected. The application has access to a set of reviews about the business entity. A condition associated with the request is determined, where a future interaction between a user and the entity is expected to occur subject to the condition. A set of factors related to the condition is identified. Using a selection criterion, a subset of the set of reviews about the entity is selected. The subset of the set of reviews is analyzed. Responsive to the analyzing, the report is generated.

### TECHNICAL FIELD

The present invention relates generally to a method, system, and computer program product for reviewing business entities. More particularly, the present invention relates to a method, system, and computer program product for conditional analysis of business reviews.

### BACKGROUND

Business entities (hereinafter, “entities”, “entity”) are often reviewed by their actual or prospective patrons, clients, partners, visitors, observers, and the like (hereinafter, “users”, “user”). Some examples of such entities are restaurants, shops, outlets, vendors, retailers, distributors, brokers, agents or agencies, and other similar enterprises, where users transact or attempt to transact some type of business transaction, e.g., a financial transaction, a bartering transaction, or an agreement.

Many websites and review sources collect review comments, review ratings, feedback messages, problem and solution reports, and other similarly purposed content (hereinafter, “reviews”, “review”) on entities from users. These websites, repositories, and other sources of review information (hereinafter, “sources”, “source”) also analyze the reviews collected on an entity and provide reports, such as rating or ranking of the entity.

For example, one website categorizes the entities that can be reviewed on that website according to their locations, type of business, or both. The website then allows users to provide reviews about those entities. The website maintains a database of the reviews provided by various users for various entities.

When a user requests a report on a particular entity from the website, the website analyzes all available reviews about the requested entity, and provides the user a rating value (rating) of that entity. The rating value attempts to summarize various individual ratings supplied by the users or calculated based on the information supplied by the users in the reviews.

In some cases, the rating is supplemented with individual reviews and individual ratings supplied by the users about the requested entity. In some cases, the website also provides ratings and/or reviews of other entities that are comparable to the requested entity, such as for being situated in the same geographical area as the requested entity, or for engaging in a similar type of business as the requested entity.

### SUMMARY

The illustrative embodiments provide a method, system, and computer program product for conditional analysis of business reviews. An embodiment includes a method for conditional analysis of business reviews. The embodiment detects a request for a report on a business entity, the request being directed to an application executing in a data processing system, the application having access to a set of reviews about the business entity. The embodiment determines, using a processor and a memory, a condition associated with the request, wherein a future interaction between a user and the entity is expected to occur subject to the condition. The embodiment identifies a set of factors related to the condition. The embodiment selects, using a selection criterion, a subset of the set of reviews about the entity. The embodiment analyzes the subset of the set of reviews. The embodiment outputs, responsive to the analyzing, the report.

Another embodiment includes a computer program product for conditional analysis of business reviews. The embodiment further includes one or more computer-readable tangible storage devices. The embodiment further includes program instructions, stored on at least one of the one or more storage devices, to detect a request for a report on a business entity, the request being directed to an application executing in a data processing system, the application having access to a set of reviews about the business entity. The embodiment further includes program instructions, stored on at least one of the one or more storage devices, to determine, using a processor and a memory, a condition associated with the request, wherein a future interaction between a user and the entity is expected to occur subject to the condition. The embodiment further includes program instructions, stored on at least one of the one or more storage devices, to identify a set of factors related to the condition. The embodiment further includes program instructions, stored on at least one of the one or more storage devices, to select, using a selection criterion, a subset of the set of reviews about the entity. The embodiment further includes program instructions, stored on at least one of the one or more storage devices, to analyze the subset of the set of reviews. The embodiment further includes program instructions, stored on at least one of the one or more storage devices, to output, responsive to the analyzing, the report.

Another embodiment includes a computer system for conditional analysis of business reviews. The embodiment further includes one or more processors, one or more computer-readable memories and one or more computer-readable storage devices. The embodiment further includes program instructions, stored on at least one of the one or more storage devices for execution by at least one of the one or more processors via at least one of the one or more memories, to detect a request for a report on a business entity, the request being directed to an application executing in a data processing system, the application having access to a set of reviews about the business entity. The embodiment further includes program instructions, stored on at least one of the one or more storage devices for execution by at least one of the one or more processors via at least one of the one or more memories, to determine, using a processor and a memory, a condition associated with the request, wherein a future interaction between a user and the entity is expected to occur subject to the condition. The embodiment further includes program instructions, stored on at least one of the one or more storage devices for execution by at least one of the one or more processors via at least one of the one or more memories, to identify a set of factors related to the condition. The embodiment further includes program instructions, stored on at least one of the one or more storage devices for execution by at least one of the one or more processors via at least one of the one or more memories, to select, using a selection criterion, a subset of the set of reviews about the entity. The embodiment further includes program instructions, stored on at least one of the one or more storage devices for execution by at least one of the one or more processors via at least one of the one or more memories, to analyze the subset of the set of reviews. The embodiment further includes program instructions, stored on at least one of the one or more storage devices for execution by at least one of the one or more processors via at least one of the one or more memories, to output, responsive to the analyzing, the report.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for conditional analysis of business reviews in accordance with an illustrative embodiment;

FIG. 4 depicts a block diagram of another example configuration for conditional analysis of business reviews in accordance with an illustrative embodiment;

FIG. 5 depicts a block diagram of an example application for conditional analysis of business reviews in accordance with an illustrative embodiment; and

FIG. 6 depicts a flowchart of an example process for conditional analysis of business reviews in accordance with an illustrative embodiment.

### DETAILED DESCRIPTION

The illustrative embodiments recognize that the presently available methods and systems for analyzing reviews and ratings of entities do not present a situation-specific opinion of the entity. For example, a requester user requests an analysis of a requested entity from a reviewing website. The summary rating of the entity, the available collection of reviews, and even the geographical or type-of-business comparative analysis with other businesses is often not very helpful to the requester because such analyzes fail to recognize the context in which the requester is requesting the analysis.

As an example, assume that the requested entity is a restaurant—restaurant XYZ, and the requester is a potential customer looking for a suitable place to arrange a business lunch. Further assume that restaurant XYZ is open for business all meals all seven days of the week, and is situated in a busy part of town, close to business centers and a sports arena.

As would be expected in many restaurant enterprises, the type of patrons who visit for lunch on a weekday is often different from the type of patrons who visit for lunch on a weekend. Suppose that the reviewing website has significantly more reviews from the weekend patrons than from the weekday patrons, and most of the weekender patrons complained about a noisy environment, slow service, and active children interruptive their dining experience.

Based on these simple facts, the illustrative embodiments recognize an example problem with the reviews and ratings analysis of restaurant XYZ with a presently available method. Using a presently available method, the website reports to the user a lower than threshold rating, due to low ratings contributed by mostly weekender patrons. The review messages displayed alongside the rating are not very helpful either because, again, they are largely from weekender patrons complaining about the above-described issues.

The illustrative embodiments recognize that the rating and the reviews presentation using presently available methods is very likely to dissuade the requester from making a reservation at restaurant XYZ for their business lunch. The illustrative embodiments further recognize that the rating and the reviews presentation are also not very helpful to restaurant XYZ because while they are dissuading the weekender patrons for the reported reasons, they are also dissuading weekday patrons for reasons that do not pertain to the weekday patron's context.

For example, suppose that the website does have some good reviews on restaurant XYZ from the weekday patrons. These good reviews include no complains of noise, slow service, or children, and provide contradictory information that the restaurant is quiet and the service is fast and courteous. However, the illustrative embodiments recognize that the presently used methods of reviewing and rating do not distinguish reviews based on the context of the review, e.g., the time at which the experience reported in a particular review was had. Consequently, the good reviews, which are more relevant to the requester's context for requesting the analysis than the bad reviews that are not related to the requester's context of a business lunch on a weekday, are lumped together anyway, resulting in a rating that is misleading given the context of the request.

The illustrative embodiments recognize that even with geographical and type-of-business based section of reviews, the presently available methods for reviewing and ranking entities is insufficient to produce analytical results that are relevant to one or more contexts of a user's request.

The illustrative embodiments used to describe the invention generally address and solve the above-described problems and other problems related to analyzing entity reviews. The illustrative embodiments provide a method, system, and computer program product for conditional analysis of business reviews.

A context or condition of a request for review analysis of an entity includes one or more expressed or implied conditions that are expected to be met by the results of a review analysis of an entity. A factor of a condition is something whose value or indication must be obtained to ascertain a value or existence of a condition.

Some examples of such context include an objective or purpose for which the requested entity is expected to be used, or a manner or circumstance in which the requested entity is expected to be used. For example, an objective or purpose may be a party, a meeting, a get-together, a discussion, a presentation, an event, an exercise, and so on, or some combination thereof. Accordingly, an example factor of such a condition is a number of persons participating.

Similarly, a manner of use may be individually, with business colleagues, with family members, with friends, with strangers, dress-code, using a particular facility e.g. a swimming pool or a bar at the entity, using a combination of things or equipment e.g. bowling lanes or workout equipment at the entity, and so on, or some combination thereof. Accordingly, an example factor of such a condition is a nature or type of activity or transaction planned.

Some more examples of context of a request include a day and/or time condition, when the requested entity is expected to be used, or a seasonal or weather condition under which the requested entity is expected to be used. For example, a day and/or time condition may be a day of the week, a particular holiday, a particular meal or meal time, on a particular festival or occasion, and so on, or some combination thereof. Accordingly, an example factor of such a condition is a calendar, a date, or a date and a time.

Similarly, a seasonal or weather condition may be during summer vacation, for fall foliage, during winter, when it might rain, when it is expected to be windy, and so on, or some combination thereof. Accordingly, an example factor of such a condition is a weather data for a location on a proposed date or period.

Some more examples of context of a request include a traffic or crowding condition that is expected to exist when the requested entity is expected to be used, or a diversion or disruptive condition that is expected to exist when the requested entity is expected to be used, and the like. For example, an traffic or crowding condition may be a condition on a particular highway at particular day and time, amount of or shortage of parking spaces in a location of the business, a sporting event near the entity, and so on, or some combination thereof. Accordingly, an example factor of such a condition is a traffic report or other indication in a particular area.

Similarly, a diversion or disruptive condition may be construction in the vicinity of the entity, hazardous road conditions in certain seasons or at certain times, remodeling or repairs at the entity or in the entity's neighborhood, and so on, or some combination thereof. Accordingly, an example factor of such a condition is a construction permit data, online posted notices, news articles pertaining to a particular area.

These example contexts and conditions, the example factors, and combinations thereof, are only described for the clarity of the various embodiments, and not to imply any limitation thereto. From this disclosure, those of ordinary skill in the art will be able to conceive many other combinations of contexts and factors of requests for review analysis and the same are contemplated within the scope of the illustrative embodiments.

An embodiment for conditional analysis of business reviews can be implemented as an application to execute in a data processing system. Some embodiments are configurable for executing in an application at a data processing system that collects the reviews and receives requests for review analysis reports. Some other embodiments are configurable for executing in an application at a data processing system that contributes a review to a review collection system, which requests review analysis reports, or both.

An embodiment detects that a user is requesting an analysis report on an entity for which reviews are available. The embodiment identifies one or more conditions that are applicable to the request.

For example, one embodiment asks the user for further information, or the user supplies further information, about why the report is being requested, what the user intends to do at the entity, how or when the user intends to use the entity, and other such specifics. Another embodiment cross-references a user's calendar with the request to estimate or speculate a likely activity contemplated at or with the entity, a date or time thereof, expected participants, and other similarly purposed information. Another embodiment infers such additional information by considering patterns of report requests made by the user over a period, other sites or information sources visited by the user within a time interval from requesting the report, other review report requests made y the user, and so on.

For a condition in the set of conditions, an embodiment further determines a set of factors related to the condition. The embodiment accesses one or more sources to obtain one or more values, indications, or a combination thereof, for a factor in the set of factors.

Using the factor values, the conditions, or a combination thereof, am embodiment constructs a selection criterion. The selection criterion is usable to select those reviews from a set of reviews related to the entity, which match the selection criterion, e.g., within a tolerance limit of a value.

An embodiment sends the selection criterion to another application that is configured to access a reviews repository, causing the application to select those reviews from the reviews repository which match the selection criterion. One example embodiment searches the reviews repository in a similar manner, but without causing another application to do so.

The selected reviews are then analyzed. In one embodiment, an existing review analysis tool, application, or component is used for analyzing the selected reviews and producing a report of the analysis. In another embodiment, the embodiment provides a mechanism for analyzing the selected reviews and providing a report of the analysis.

In one embodiment, the analysis is performed according to one or more analysis rules. For example, when less than a threshold number of reviews are returned, an embodiment uses, or causes to be used, an extrapolation method such that a result of analysis based on sparse data is a better representation of the reviews as compared to summarizing only the selected reviews.

As an example, an analysis rule according to an embodiment assigns a weight to a factor or a condition that participates in the selection criterion. Different factors or conditions may be assigned same of different weights in this manner. A weight value is indicative of an importance, prominence, or relative significance of the corresponding factor or condition amongst the factors or conditions participating in the search criterion.

A review may be selected because the review matches a weighted factor within the specified tolerance. If so, that review or a rating value therein is weighted by the weight of the corresponding weighted factor.

For example, suppose that time sensitivity is a factor with weight W1, weather sensitivity is a factor with weight W2, and W3 is a weight that is attributed to other reasons for selecting a review. Further suppose that only three ratings R1, R2, and R3 are selected in a search. If review R1 is selected because of the time sensitivity factor, the rating value of R1 is multiplied by W1. If review R2 is selected because of the weather sensitivity factor, the rating value of R2 is multiplied by W2. If review R3 is selected for some other reason, the rating value of R3 is multiplied by W3.

The analysis rule determines a sum of the weighted ratings of R1, R2, and R3. Thus, an embodiment produces a review analysis report that is more reflective of, and relevant to, the context in which the user requested the reviews analysis report, as compared to a prior art analysis that would be performed without selecting R1-R3 from n available reviews, and further without weighting the selected reviews R1-R3.

One embodiment allows comparative reporting of reviews. For example, in the above example case, the embodiment further produces a report according to the prior-art analysis of all available reviews, so that the user can compare the two reports. For example, suppose the report according to an embodiment using weighted selected reviews indicated, “Restaurant XYZ has a rating of 4.3 out of 5 for holding a business lunch next week.” Further suppose that a prior art report indicated, “Restaurant XYZ has a rating of 3.1 out of 5.” When an embodiment provides both reports to the user, the user has better information to conclude, “Restaurant XYZ generally has a rating of 3.1 out of 5, but has a rating of 4.3 out of 5 for holding a business lunch next week.”

According to another embodiment, some relationships between the correlations between conditions that are related to report requests, and the factors that are related to those conditions, can be pre-determined or pre-configured. Accordingly, such an embodiment, when executing in conjunction with a review application server, can improve the intake of new reviews and ratings as users provide them. For example, a new review submitted by a user for an entity can be tagged with one or more factors, one or more conditions, or both.

As an example, the embodiment tags a new review of restaurant XYZ with a day, a date, and/or a time of the experience reported in the review, a type of patron who is reporting the review, a weather or traffic condition that existed at the date-time of the reported experience, a distraction that existed at that date-time around restaurant XYZ, and any number of other similarly purposed conditions and factors as described herein. By tagging a review in this manner, the embodiment enables better searching for the reviews in the reviews repository when a report is to be generated by taking into consideration conditions and factors related to the report request.

A method of an embodiment described herein, when implemented to execute on a device or data processing system, comprises substantial advancement of the functionality of that device or data processing system in conditional analysis of business reviews. For example, selecting reviews, and analyzing the selected reviews according to analysis rules enables the device or data processing system to produce reporting that is more useful to the user and a better representation of the reported entity than the prior-art. For example, a manner of reporting according to an embodiment, either just with the report based on selected weighted reviews, or with more than one comparative reports, advantageously allows a user to arrive at a better informed conclusion about an entity's suitability in the user's contemplated context. Such a manner of reporting is also a fairer representation of the entity without diluting the entity's favorable features, which are favorable for a given context, with irrelevant or less relevant reviews. Such manner of analyzing entity reviews is unavailable in presently available devices or data processing systems. Thus, a substantial advancement of such devices or data processing systems by executing a method of an embodiment improves the usefulness and pertinence of entity reviews in a context contemplated by the user.

The illustrative embodiments are described with respect to certain reviews, reviews repositories, factors, conditions, contexts, information sources, analyses, rules, reports, weights, values, calculations, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments.

Furthermore, a particular illustrative embodiment may have some, all, or none of the advantages listed above.

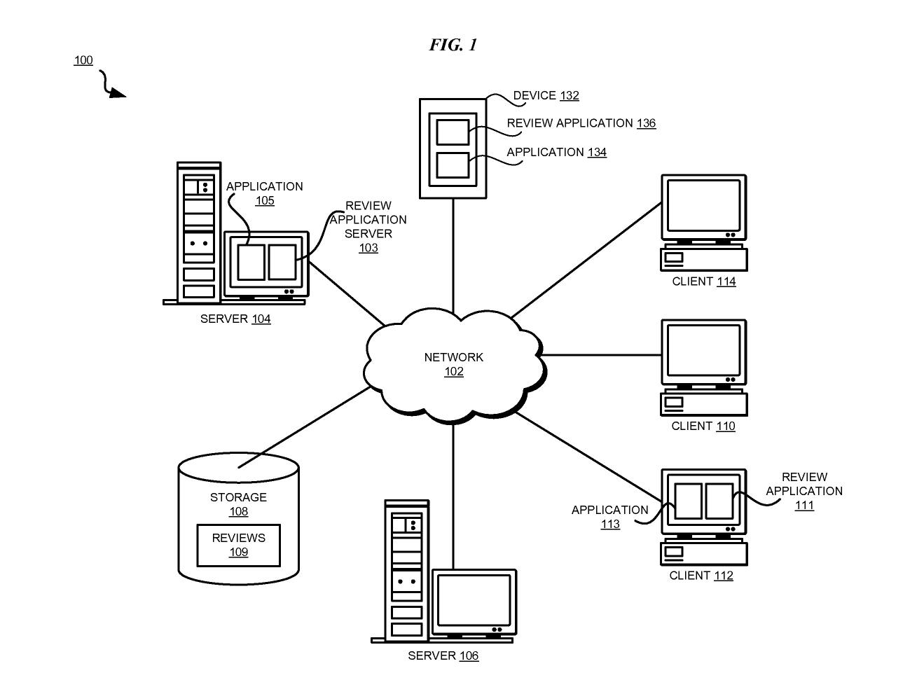

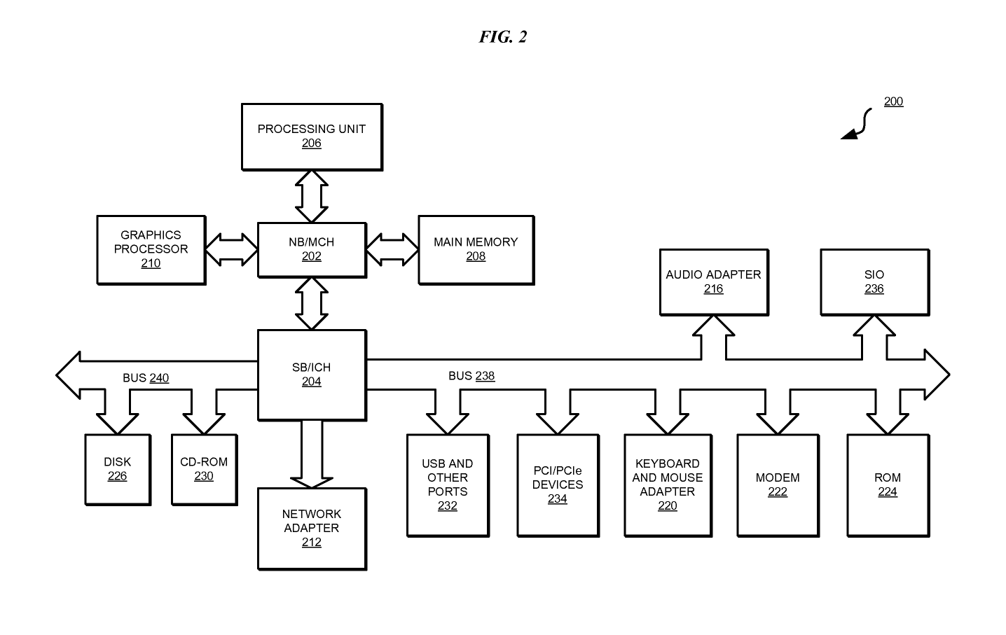

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device that can be configured for requesting entity reviews and analysis reports. Review application 136 is an example client-side application capable of communicating with one or more repositories or collectors of reviews. Application 134 implements an embodiment described herein and operates in conjunction with review application 136. As an example, using application 134 or review application 136 or a combination thereof, a user can provide context information, e.g., specific conditions contemplated in relation to the entity whose reviews or report is requested from device 132. A report according to an embodiment, whether generated from application 134, review application server 103, or application 105 is presentable using review application 136. Review application 111 and application 113 on client 112 operate in a manner similar to review application 136 and application 134, respectively. Review application server 103 on server 104 operates to collect reviews from users, such as from device 132 and client 112. Review application server 103 stores the collected reviews in reviews repository 109 using storage 108. Review application server 103 also operates to receive review analysis requests from, and delivers the requested analysis reports to, device 132 and client 112. Application 105 implements an embodiment described herein and operates in conjunction with review application 103.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), Linux® (Linux is a trademark of Linus Torvalds in the United States and other countries), iOS™ (iOS is a trademark of Cisco Systems, Inc. licensed to Apple Inc. in the United States and in other countries), or Android™ (Android is a trademark of Google Inc., in the United States and in other countries). An object oriented programming system, such as the Java™ programming system, may run in conjunction with the operating system and provide calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as application 105, application 113, or application 134 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

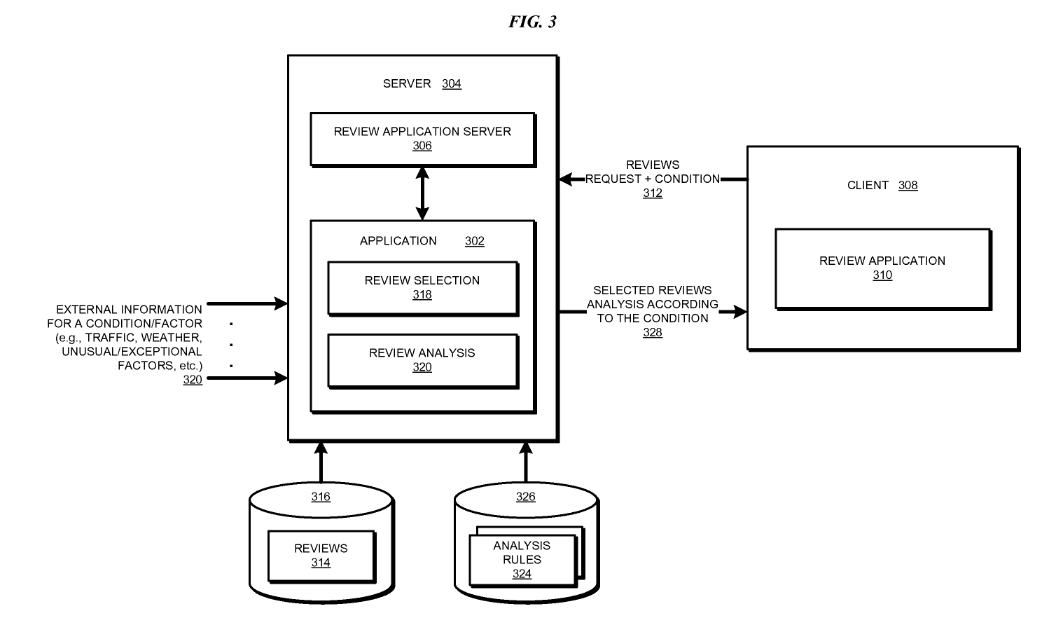

With reference to FIG. 3, this figure depicts a block diagram of an example configuration for conditional analysis of business reviews in accordance with an illustrative embodiment. Application 302 is an example of application 105 in FIG. 1. Application 302 operates in data processing system 304, labeled “server”, in conjunction with review application server 306. Data processing system 304 is an example of server 104, and review application server 306 is an example of review application server 103, respectively, in FIG. 1. Data processing system 308, labeled “client”, is an example of client 112, and review application 310 is an example of review application 111, respectively, in FIG. 1.

A user, using review application 310 at client 308 sends request 312 for a report on an entity. Using a modified form of review application 310, as modified by an embodiment, or by executing an application (not shown) implementing an embodiment on client 308, the user further sends information descriptive of one or more condition with request 312.

Review application server 306 receives request 312 and any associated conditions. Review application server 306 passes the condition of request 312 to application 302. Review application server 306 extracts, from reviews repository 314 in storage 316, a set of reviews pertaining to the entity in request 312. Application 302, using operation 318, selects a subset of the reviews.

As described in this disclosure, application 302 determines one or more factors corresponding to a condition associated with request 312. For one or more such conditions and/or one or more corresponding factors, application receives information 320 from one or more external sources. Application 302 incorporates information 320 in forming the selection criterion that operation 318 uses for selecting the subset of reviews.

Application 302, using operation 320, analyzes the selected subset of the reviews, such as by using an analysis rule from set 324 of analysis rules in repository 326. Generally, any suitable data analysis method is usable to analyze the subset of reviews within the scope of the illustrative embodiments. Additional or different analysis under certain circumstances, such as when fewer than a threshold number of reviews are in the subset, may be needed, and logic therefor can be configured in one or more analysis rules as described in this disclosure. An example of weighting certain reviews is described elsewhere in this disclosure. Other circumstances can be similarly addressed by configuring a suitable analysis rule.

Application 302 returns, or causes review application server 306 to return, data 328. In one embodiment, data 328 includes the report of the analysis of the subset. In another embodiment, data 328 includes the subset of selected reviews and the report of the analysis of the subset. Review application 310 presents, or an embodiment causes review application 310 to present data 428.

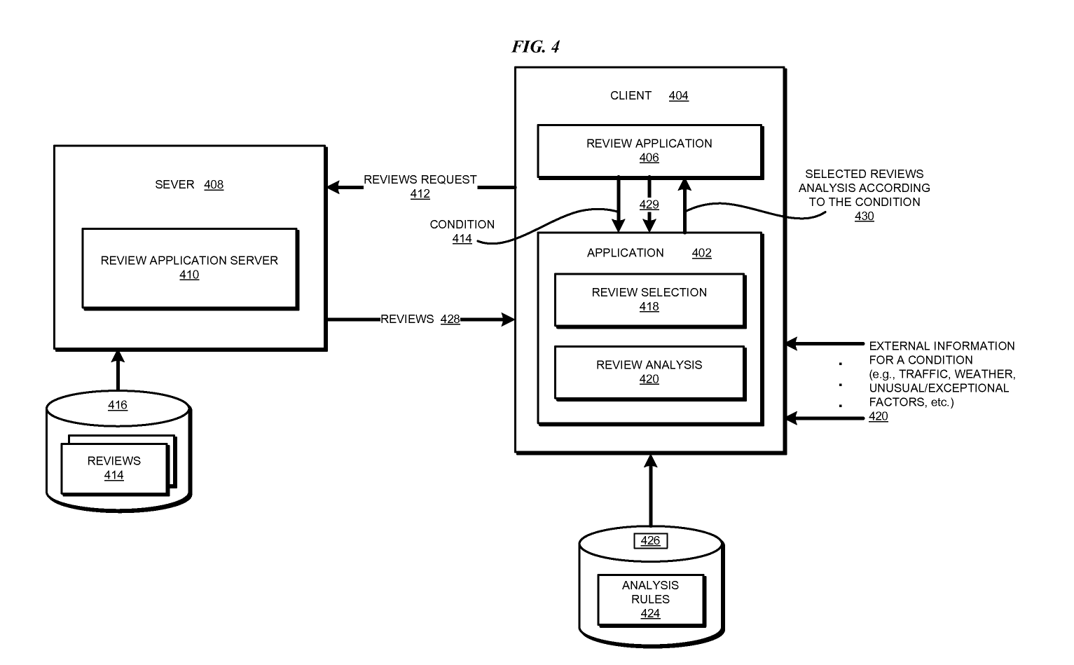

With reference to FIG. 4, this figure depicts a block diagram of another example configuration for conditional analysis of business reviews in accordance with an illustrative embodiment. Application 402 is an example of application 113 or 134 in FIG. 1. Application 402 operates in data processing system 404, labeled “client”, in conjunction with review application server 406. Data processing system 404 is an example of client 112 or device 132, and review application 406 is an example of review application 111 or 136, respectively, in FIG. 1. Data processing system 408, labeled “server”, is an example of server 104, and review application server 410 is an example of review application server 103 in FIG. 1.

A user, using review application 406 at client 404 sends request 412 for a report on an entity. Using a modified form of review application 406, as modified by an embodiment, or using application 402, the user further specifies information descriptive of one or more condition 417 applicable to request 412.

Review application server 410 receives request 412. Review application server 410 extracts, from reviews repository 414 in storage 416, a set of reviews pertaining to the entity in request 412. Review application server 410 returns data 428 to review application 406. Review application 406 makes the set of reviews received in data 428 available to application 402 as data 429.

Application 402, using operation 418, selects a subset of the reviews. As described in this disclosure, application 402 determines one or more factors corresponding to condition 417 associated with request 412. For one or more such conditions and/or one or more corresponding factors, application receives information 420 from one or more external sources. Application 402 incorporates information 420 in forming the selection criterion that operation 418 uses for selecting the subset of reviews.

Application 402, using operation 420, analyzes the selected subset of the reviews, such as by using an analysis rule from set 424 of analysis rules in repository 426. Again, generally, any suitable data analysis method is usable to analyze the subset of reviews within the scope of the illustrative embodiments. Additional or different analysis under certain circumstances, such as when fewer than a threshold number of reviews are in the subset, may be needed, and logic therefor can be configured in one or more analysis rules as described in this disclosure. An example of weighting certain reviews is described elsewhere in this disclosure. Other circumstances can be similarly addressed by configuring a suitable analysis rule.

Application 402 presents, or causes review application 406 to present data 430. In one embodiment, data 430 includes the report of the analysis of the subset. In another embodiment, data 430 includes the subset of selected reviews and the report of the analysis of the subset.

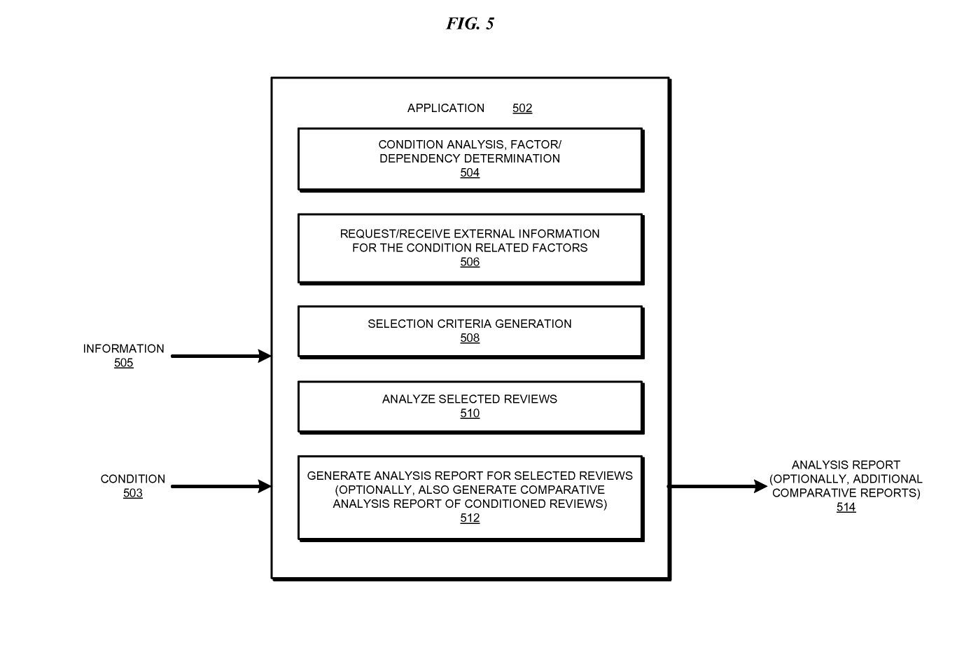

With reference to FIG. 5, this figure depicts a block diagram of an example application for conditional analysis of business reviews in accordance with an illustrative embodiment. Application 502 can be implemented as application 302 in FIG. 3 or application 402 in FIG. 4.

Application 502 receives condition 503. Condition 503 is an example of a condition transmitted in relation to request 312 in FIG. 3 or condition 417 in FIG. 4, depending upon the data processing system on which application 502 is implemented.

Component 504 performs an analysis of condition 503, such as to determine one or more factors on which condition 503 depends. Component 506 requests one or more external information sources (not shown) for information related to one or more of those factors and/or condition 503. Component 506 receives information 505 in response to the request. Information 505 is an example of information 326 in FIG. 3 or information 426 in FIG. 4, depending upon the data processing system on which application 502 is implemented.

Component 508 generates one or more selection criterion based on condition 503, factors of condition 503, and information 505 received about those factors and/or condition 503. Component 508 uses the generated selection criterion to select a subset of a set of reviews about an entity, whose report is requested in conjunction with condition 503.

Component 510 analyzes the selected subset of reviews. For example, component 510 uses one or more analysis rules from analysis rules repository 324 in FIG. 3 or analysis rules repository 426 in FIG. 4, depending upon the data processing system on which application 502 is implemented.

Component 512 generates report 514 of the analysis performed on the subset of reviews by component 510. Optionally, component 512 also produces one or more other reports for comparison with report 514. In one embodiment, an additional report is a result of an additional analysis performed by component 510, such as on the set of the reviews, the same subset of the reviews, or a different subset of the reviews. In another embodiment, an additional report is produced by a review application server, e.g., review application server 306 in FIG. 3, and forwarded to application 502.

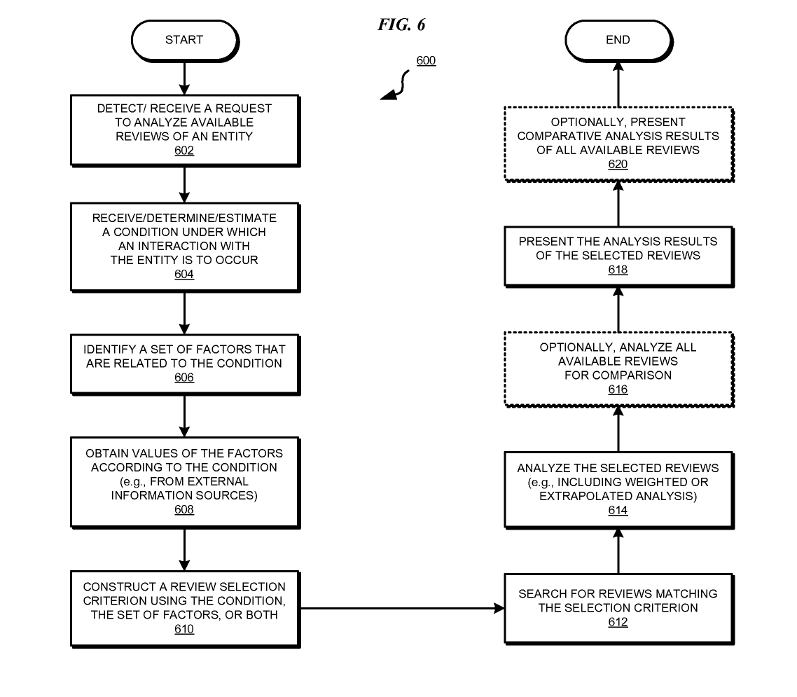

With reference to FIG. 6, this figure depicts a flowchart of an example process for conditional analysis of business reviews in accordance with an illustrative embodiment. Process 600 can be implemented in application 502 in FIG. 5.

The application detects or receives a request to analyze available reviews of an entity (block 602). The application receives, determines, estimates, or correlates a condition under which an interaction with the entity of the request is to occur (block 604).

The application identifies a set of factors that are related to the condition (block 606). The application obtains values from external information sources for the factors (block 608). For example, if the interaction with the entity is to occur on the evening of next Saturday, a factor related to the condition could be the weather on the evening of next Saturday. A value of such a factor would be the weather forecast for the geographical area of the entity on the evening of next Saturday. Other conditions, factors, values of factors as relates to the given condition, can be determined in a manner analogous to this example.

The application constructs a review selection criterion using the condition, the set of factors, and the values therefor (block 610). The application searches for one or more reviews that match the selection criterion (block 612).

The application analyzes the selected reviews (block 614). In block 614, the application also performs weighting as described in this disclosure and other methods for accommodating anomalies, discrepancies, scarcity, filtering, and other variations in the selected reviews.

Optionally, the application may also analyze all available reviews (block 616). For example, under some circumstances, the condition or the factors may not warrant removing any reviews from consideration. In such a case, the application can analyze all available reviews in block 616. In some other cases, the application may perform the additional analysis of block 616 to provide comparative information to the user as described in the disclosure.

The application presents the results of the analysis of the selected reviews from block 614 (block 618). Optionally, e.g., when block 616 is executed, the application also presents the additional results, e.g., the comparative analysis results of all available reviews (block 620). The application ends process 600 thereafter.

Thus, a computer implemented method, system or apparatus, and computer program product are provided in the illustrative embodiments for conditional analysis of business reviews. Where an embodiment or a portion thereof is described with respect to a type of device, the computer implemented method, system or apparatus, the computer program product, or a portion thereof, are adapted or configured for use with a suitable and comparable manifestation of that type of device.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for conditional analysis of business reviews, the method comprising:
detecting a request for a report on a business entity, the request being directed to an application executing in a data processing system, the application having access to a set of reviews about the business entity;
determining, using a processor and a memory, a condition associated with the request, wherein a future interaction between a user and the entity is expected to occur subject to the condition;
identifying a set of factors related to the condition;
selecting, using a selection criterion, a subset of the set of reviews about the entity;
analyzing the subset of the set of reviews; and
outputting, responsive to the analyzing, the report.

2. The method of claim 1, further comprising:
determining that a number of reviews in the subset of reviews is below a threshold number;
assigning a first weight to a first factor from the set of factors, wherein the first weight is higher than a second weight assigned to a second factor from the set of factors;
determining that a first review in the subset of reviews corresponds to the first factor, and that a second review in the subset of reviews corresponds to the second factor; and
relying more on the first review than the second review in the analyzing.

3. The method of claim 1, further comprising:
analyzing a second subset of the set of reviews according to a second analysis rule, wherein the subset of the set of reviews is analyzed using a first analysis rule; and
outputting, responsive to the analyzing the second subset of reviews, a second report such that comparing the report and the second report identifies a relevance of the condition to (i) the set of reviews and (ii) the entity.

4. The method of claim 1, wherein a review in the subset of reviews is selected because a value of a component of the review satisfies the selection criterion within a tolerance value.

5. The method of claim 4, further comprising:
establishing, prior to detecting the request, a relationship between the condition and the set of factors;
associating with the review in the subset of reviews, prior to detecting the request and at a time of receiving the review into a review repository, a subset of the set of factors, where in a factor in the associated subset of the set of factors comprises the component of the review;
assigning a value to the component based on a value the factor in the associated subset of the set of factors had when an experience reported in the review occurred.

6. The method of claim 1, further comprising:
constructing the selection criterion using a subset of the set of factors.

7. The method of claim 6, further comprising:
obtaining, from a data source, a value corresponding to a factor in the subset of the set of factors, wherein the value is used in the selection criterion.

8. The method of claim 1, wherein the condition depends on a factor in the set of factors such that changing a value of the factor changes the condition.

9. The method of claim 1, further comprising:
receiving, as an input from the user, the condition.

10. The method of claim 1, further comprising:
correlating the request with a data entry in a second application; and
estimating the condition responsive to a relation between the request and the data entry.

11. the method of claim 10, wherein the second application comprises a calendaring applications, and wherein the data entry comprises a calendar entry in the calendaring application.

12. The method of claim 1, wherein the application obtains the set of reviews from a plurality of users.

13. The method of claim 1, wherein a review in the set of reviews comprises a comment and a rating value provided by a second user to the application.

14. The method of claim 1, wherein the method is embodied in a computer program product comprising one or more computer-readable tangible storage devices and computer-readable program instructions which are stored on the one or more computer-readable tangible storage devices and executed by one or more processors.

15. The method of claim 1, wherein the method is embodied in a computer system comprising one or more processors, one or more computer-readable memories, one or more computer-readable tangible storage devices and program instructions which are stored on the one or more computer-readable tangible storage devices for execution by the one or more processors via the one or more memories and executed by the one or more processors.

16. A computer program product for conditional analysis of business reviews, the computer program product comprising:
one or more computer-readable tangible storage devices;
program instructions, stored on at least one of the one or more storage devices, to detect a request for a report on a business entity, the request being directed to an application executing in a data processing system, the application having access to a set of reviews about the business entity;
program instructions, stored on at least one of the one or more storage devices, to determine, using a processor and a memory, a condition associated with the request, wherein a future interaction between a user and the entity is expected to occur subject to the condition;
program instructions, stored on at least one of the one or more storage devices, to identify a set of factors related to the condition;
program instructions, stored on at least one of the one or more storage devices, to select, using a selection criterion, a subset of the set of reviews about the entity;
program instructions, stored on at least one of the one or more storage devices, to analyze the subset of the set of reviews; and
program instructions, stored on at least one of the one or more storage devices, to output, responsive to the analyzing, the report.

17. The computer program product of claim 16, further comprising:
program instructions, stored on at least one of the one or more storage devices, to determine that a number of reviews in the subset of reviews is below a threshold number;
program instructions, stored on at least one of the one or more storage devices, to assign a first weight to a first factor from the set of factors, wherein the first weight is higher than a second weight assigned to a second factor from the set of factors;
program instructions, stored on at least one of the one or more storage devices, to determine that a first review in the subset of reviews corresponds to the first factor, and that a second review in the subset of reviews corresponds to the second factor; and
program instructions, stored on at least one of the one or more storage devices, to rely more on the first review than the second review in the analyzing.

18. The computer program product of claim 16, further comprising:
program instructions, stored on at least one of the one or more storage devices, to analyze a second subset of the set of reviews according to a second analysis rule, wherein the subset of the set of reviews is analyzed using a first analysis rule; and
program instructions, stored on at least one of the one or more storage devices, to output, responsive to the analyzing the second subset of reviews, a second report such that comparing the report and the second report identifies a relevance of the condition to (i) the set of reviews and (ii) the entity.

19. The computer program product of claim 16, wherein a review in the subset of reviews is selected because a value of a component of the review satisfies the selection criterion within a tolerance value.

20. A computer system for conditional analysis of business reviews, the computer system comprising:
one or more processors, one or more computer-readable memories and one or more computer-readable storage devices;
program instructions, stored on at least one of the one or more storage devices for execution by at least one of the one or more processors via at least one of the one or more memories, to detect a request for a report on a business entity, the request being directed to an application executing in a data processing system, the application having access to a set of reviews about the business entity;
program instructions, stored on at least one of the one or more storage devices for execution by at least one of the one or more processors via at least one of the one or more memories, to determine, using a processor and a memory, a condition associated with the request, wherein a future interaction between a user and the entity is expected to occur subject to the condition;
program instructions, stored on at least one of the one or more storage devices for execution by at least one of the one or more processors via at least one of the one or more memories, to identify a set of factors related to the condition;
program instructions, stored on at least one of the one or more storage devices for execution by at least one of the one or more processors via at least one of the one or more memories, to select, using a selection criterion, a subset of the set of reviews about the entity;
program instructions, stored on at least one of the one or more storage devices for execution by at least one of the one or more processors via at least one of the one or more memories, to analyze the subset of the set of reviews; and
program instructions, stored on at least one of the one or more storage devices for execution by at least one of the one or more processors via at least one of the one or more memories, to output, responsive to the analyzing, the report.
